(19) United States
(12) Patent Application Publication
(10) Pub. No.: US 2007/0068289 A1
(43) Pub. Date: Mar. 29, 2007

(54) FORCE GENERATOR IMPULSE WAVE DRIVE MECHANISM

(76) Inventor: PAUL ELBERT WAITERS SR., REDWOOD CITY, CA (US)

Correspondence Address: PAUL WAITERS, 531 WOODSIDE ROAD APT#303, REDWOOD CITY, CA, 94061, US

(21) Appl. No.: 11/162,947

(22) Filed: Sep. 28, 2005

(51) Int. Cl. F16H 27/04

(52) U.S. Cl. 74/83

(57) ABSTRACT

Propulsive systems today are based on one of the Newtonian principles, expelling matter from the host, which is a basic reaction. One can find these principles employed in such technologies as rockets, jet engines, ion drive systems and lifter technology. The force generator is a unified mechanism, based propulsion system. It employs a wave impact technology by transferring kinetic forces from one body to the next. By using force generator technology, we are gaining unlimited altitude and limitless vehicle definition.

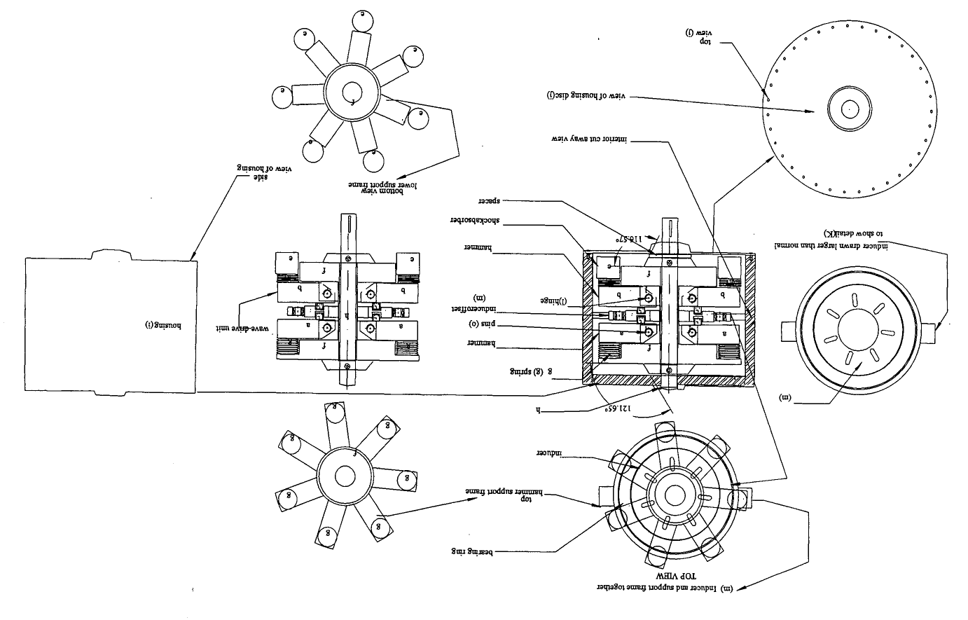

### BRIEF DESCRIPTION OF SEVERAL VIEWS OF THE DRAWING

1) The Force Generator is a self-contained impact wave drive unit comprising of a cylinder support housing (i), which supports the main axial (h) and is inserted through the hammer support frame (f).

2) The support frame (f) has a total of fourteen hammers (a,b); the hammers (a,b) are in direct opposition of each other and pivots on the hinges (l).

3) On each hammer (a,b) there is a pin (o). The pins (o) fit into a slot on the inner inducer (m). The outer inducer (k) remains stationary while the inside inducer (m) rotates with the frame (f).

4) The inducer (k) is offset by a degree, creating a pull on the right side of the hammers (a,b) and a pushing on a left side of hammers (a,b). While the frame rotates with the inducer (m), it causes the hammers (a,b) to impact the frame (f) in two areas (e,g). Hammers (a) on the left upper side have an elastic component (g). Hammers (b) on the left lower side have an inelastic component (e).

5) Shock absorbers (e) on the frame (f) allow for kinetic transfer to the frame (f). The shock absorbers absorb the kinetic energy, allowing only a fraction of the kinetic energy to transfer to the frame (f) in the direction of hammers (b).

6) The springs (g) on the frame (f) allows for kinetic transfer to the frame (f). The springs transfer approximately 99% of the kinetic energy to the frame (f). Because more energy was transferred in the direction of hammers (a) than hammers (b), it is from this ratio propulsive forces are generated.

7) While the frame (f) is spinning in the housing (i), the unit is sealed with a disk (j) and supported by thirty-six screws. When the main axial (h) is connected to rotational energy, said unit will provide the user with a self-contained impact wave based propulsion system.

What is claimed is:

1. The Force Generator is a self-contained impact wave drive unit comprising of a support frame (f), which is supported by the main axial (h), and is inserted through the support housing (i). The disk (j) will seal the unit, which will completely enclose the propulsion system. When the main axial (h) is connected to rotational energy, said unit will provide the user with self-contained wave based propulsion.

2-8. (canceled)
